(19) United States
(12) Patent Application Publication
(10) Pub. No.: US 2014/0185107 A1
(43) Pub. Date: Jul. 3, 2014

(54) METHOD AND DEVICE FOR INDICATING SCANNING CONDITION AND SCANNING APPARATUS AND SCANNING SYSTEM RELATED THERETO

(71) Applicant: Shenyang Neusoft Medical Systems Co., Ltd., Shenyang (CN)

(72) Inventors: Shuangxue LI, Shenyang (CN); Mei Ma, Shenyang (CN); Xinliang Li, Shenyang (CN)

(73) Assignee: Shenyang Neusoft Medical Systems Co., Ltd., Shenyang (CN)

(21) Appl. No.: 14/072,793

(22) Filed: Nov. 6, 2013

(30) Foreign Application Priority Data
Dec. 30, 2012 (CN) 201210590889.4

(51) Int. Cl. H04N 1/23

(52) U.S. Cl. CPC H04N 1/2392
USPC 358/474

(57) ABSTRACT

A method and device for indicating a scanning condition and a scanning apparatus and scanning system related thereto are provided. The method includes: converting a scanning condition of a scanning apparatus into a control instruction for controlling a light strip to provide an indication; and executing the control instruction to control the light strip to provide the indication in the case of the scanning condition, wherein the light strip is mounted on an exterior of the scanning apparatus. Thus, the scanning condition of a scanning apparatus is converted into a control instruction for controlling the light strip to provide the indication, and the control instruction can be executed to control the light strip on the exterior of the scanning apparatus to indicate the scanning process when the scanning condition of the medical-scanning apparatus occurs.

This application claims the priority of Chinese Patent Application No. 201210590889.4, entitled “METHOD AND DEVICE FOR INDICATING SCANNING CONDITION AND SCANNING APPARATUS AND SCANNING SYSTEM RELATED THERETO”, filed with the Chinese State Intellectual Property Office on Dec. 30, 2012, which is incorporated by reference in its entirety herein.

### FIELD OF THE INVENTION

The present disclosure relates to the field of medical scanning diagnostics, and in particular to a method and device for indicating a scanning condition and a scanning apparatus and scanning system related thereto.

### BACKGROUND OF THE INVENTION

Medical-scanning apparatus with high precision, such as CT, MRI and PET, serving as a detection means indispensable for detecting diseases, has been widely used. An advanced medical-scanning apparatus should not only provide clear and accurate images and be operated conveniently and comfortably, but also pay attention to human experience in multiple aspects.

In prior art, this kind of products pay more attentions to physical feeling of a patient, such as providing comfortable mattress, multifunctional supporting cushion and smoothly-moved scanning bed. However, the psychological variable of the patient is ignored, or the sensory effect of the appearance of the scanning apparatus, such as color selection, is only cared. The problems of the patient are often that he/she can not know the scanning condition in the examination, and can not know which step the scanning is proceeded to and when it will be completed. Therefore, the patient is always in a manipulated and nervous condition, besides the ignorance of the condition of his/her body; and the patient will be more confused and even scared.

Furthermore, when the apparatus is used, the scanning condition can not be known from the exterior of the device directly, and thus the operator can not give attention to the observation of the patient and the scanning condition simultaneously.

### SUMMARY OF THE INVENTION

In view of this, an object of the present disclosure is to provide a method and device for indicating a scanning condition and a scanning apparatus and a scanning system related thereto, for indicating directly the scanning condition on the exterior of the apparatus during the scanning.

A method for indicating a scanning condition is provided according to the present disclosure, and the method includes:

converting a scanning condition of a scanning apparatus into a control instruction for controlling a light strip to provide an indication; and

executing the control instruction for controlling the light strip to provide the indication in the case of the scanning condition, wherein the light strip is mounted on an exterior of the scanning device.

Optionally, the converting the scanning condition of a scanning apparatus into a control instruction for controlling a light strip to provide an indication may include: converting a scanning process condition of the scanning apparatus into the control instruction for controlling the light strip to provide an indication; and

the executing the control instruction in the case of the scanning condition may include executing the control instruction in the case of the scanning process condition.

Optionally, the converting the scanning condition of a scanning apparatus into a control instruction for controlling a light strip to provide an indication may include: converting a working condition of the scanning apparatus into a first control instruction for controlling the light strip to provide the indication, and converting a fault condition of the scanning apparatus into a second control instruction for controlling the light strip to provide the indication; and

the executing the control instruction to control the light strip to provide the indication in the case of the scanning condition may include: executing the first control instruction to control the light strip to provide the indication in the case of the working condition, and executing the second control instruction to control the light strip to provide the indication in the case of the fault condition.

Optionally, the executing the control instruction for controlling the light strip to provide the indication may include:

sending the control instruction to a light strip control device, wherein the light strip control device executes the control instruction for controlling the light strip to provide the indication.

Optionally, the sending the control instruction to the light strip control device may include:

sending the control instruction to a frame control system, and send by the frame control system the control instruction to the light strip control device.

Optionally, the sending the control instruction to a frame control system may include sending the control instruction to the frame control system via the Ethernet or a serial bus; and

the send by the frame control system the control instruction to the light strip control device may include: send by the frame control system the control instruction to the light strip control device via a serial bus,

wherein the light strip control device executes the control instruction for controlling the light strip to provide the indication may include: control the light strip to provide the indication by the light strip control device via a light strip control bus.

Optionally, the converting the scanning process condition of the scanning apparatus into the control instruction for controlling the light strip to provide the indication may include:

converting a beginning condition of a scanning process into a control instruction for controlling a front of the light strip to emit light for providing the indication, and converting a process from the beginning condition to an ending condition of the scanning process into a control instruction for controlling the light strip to emit light for providing the indication sequentially in a direction away from the front; or

converting a beginning condition of a scanning process into a control instruction for controlling the light strip to emit light for providing an indication entirely and simultaneously, and converting a process from the beginning condition to an ending condition of the scanning process into a control instruction for controlling the light strip to be changed from emitting light for providing the indication entirely and simultaneously to turning off one by one sequentially; or

converting a process from a beginning condition to a condition before an ending condition of the scanning process into a control instruction for controlling the light strip to alternately switch between emitting light for providing an indication entirely and furthest and turning off entirely, and converting the ending condition of the scanning process into a control instruction for controlling the light strip to turn off entirely; or

converting a process from a beginning condition to an ending condition of the scanning process into a control instruction for controlling the light strip to emit light for providing an indication in a gradual-luminance mode, and converting the ending condition of the scanning process into a control instruction for controlling the light strip to turn off entirely; or

dividing a process from the beginning condition to the ending condition of the scanning process into a plurality of stages, and converting each of the stages into a control instruction for controlling one segment of the light strip to emit light for providing an indication.

Optionally, the operate the light strip control device to execute the control instruction for controlling the light strip to provide the indication may include: operate the light strip control device to execute the control instruction for controlling the light strip to provide the indication separately or integrally in color or luminance, wherein the indication corresponds to the change of the scanning condition.

Optionally, the scanning apparatus may include CT apparatus. MRI apparatus, PET apparatus, PET-CT apparatus or X-ray apparatus.

A device for indicating a scanning condition is further provided according to the present disclosure, and the device includes:

a computer control unit adapted to convert a scanning condition of a scanning apparatus into a control instruction for controlling a light strip to provide an indication, and send the control instruction to an instruction executing unit; and

the instruction executing unit adapted to execute the control instruction for controlling the light strip to provide the indication in the case of the scanning condition, wherein the light strip is mounted on an exterior of the scanning apparatus.

Optionally, the computer control unit may be adapted to convert a scanning process condition of the scanning apparatus into the control instruction for controlling the light strip to provide the indication; and

the instruction executing unit may be adapted to execute the control instruction for controlling the light strip to provide the indication in the case of the scanning process condition.

Optionally, the computer control unit may be adapted to convert a working condition of the scanning apparatus into a first control instruction for controlling the light strip to provide the indication, and to convert a fault condition of the scanning apparatus into a second control instruction for controlling the light strip to provide the indication; and

the instruction executing unit may be adapted to execute the first control instruction for controlling the light strip to provide the indication in the case of the working condition, and to execute the second control instruction for controlling the light strip to provide the indication in the case of the fault condition occurs.

Optionally, the instruction executing unit may be adapted to operate a light strip control device to execute the control instruction to control the light strip to provide the indication in the case of the scanning condition.

Optionally, the instruction executing unit may be adapted to send the control instruction to a frame control system, so as to send by the frame control system the control instruction to the light strip control device, wherein the light strip control device executes the control instruction for controlling the light strip to provide the indication.

Optionally, the instruction executing unit may be adapted to send the control instruction to a frame control system via the Ethernet or a serial bus, wherein the frame control system sends the control instruction to the light strip control device via a serial bus, so as to control the light strip to provide the indication by the light strip control device via a light strip control bus.

Optionally, the computer control unit may be adapted to convert a beginning condition of a scanning process into a control instruction for controlling a front of the light strip to emit light for providing the indication, and to convert a process from the beginning condition to an ending condition of the scanning process into a control instruction for controlling the light strip to emit light for providing the indication sequentially in a direction away from the front; or

the computer control unit may be adapted to convert a beginning condition of a scanning process into a control instruction for controlling the light strip to emit light for providing an indication entirely and simultaneously, and to convert a process from the beginning condition to an ending condition of the scanning process into a control instruction for controlling the light strip to be changed from emitting light for providing the indication entirely and simultaneously to turning off one by one sequentially; or

the computer control unit may be adapted to convert a process from a beginning condition to a condition before an ending condition of the scanning process into a control instruction for controlling the light strip to alternately switch between emitting light for providing an indication entirely and furthest and turning off entirely, and to convert the ending condition of the scanning process into a control instruction for controlling the light strip to turn off entirely; or

the computer control unit may be adapted to convert a process from a beginning condition to an ending condition of the scanning process into a control instruction for controlling the light strip to emit light for providing an indication in a gradual-luminance mode, and to convert the ending condition of the scanning process into a control instruction for controlling the light strip to turn off entirely; or

the computer control unit may be adapted to divide a process from a beginning condition to an ending condition of the scanning process into a plurality of stages, and to convert each of the stages into a control instruction for controlling one segment of the light strip to emit light for providing an indication.

A scanning apparatus is further provided according to the present disclosure, and the apparatus includes a light strip mounted on a housing of the scanning apparatus.

Optionally, a light strip groove may be provided on the surface of a housing of a scanning host, and the light strip may be mounted in the light strip groove.

Optionally, a light strip lid may be mounted on the light strip groove, and in the case that the light strip groove is covered with the light strip lid, the light strip is closed into the light strip groove when the light strip is placed in the light strip groove, wherein the light strip lid is made of a transparent material.

Optionally, the light strip may be any one or a combination of:

a LED light strip; or

a light strip including edge lit photoconductive materials; or

a bar-like light strip including independent illuminants or photoconductive materials formed in a straight line or an arc.

Optionally, the color or luminance of the light strip may be controlled separately or integrally to correspond to a change of a scanning condition.

Optionally, the scanning apparatus may be a CT scanning apparatus, and the light strip mounted on the housing of the CT scanning host may include any one or a combination of:

a light strip mounted on a principal plane of a front housing of the CT scanning host; or

a light strip mounted at the middle position of each of housings at the left and right sides of a scanning bed of the CT scanning host; or

a circle of light strip mounted around the breathing navigation component at the back housing of the CT scanning host.

A scanning system is further provided according to the present disclosure, and the system includes:

the device for indicating a scanning condition as stated above, adapted to convert the scanning condition of a scanning apparatus into a control instruction for controlling a light strip to provide an indication, and to execute the control instruction to control the light strip to provide the indication in the case of the scanning condition, wherein the light strip is mounted on the exterior of the scanning apparatus; and

a scanning apparatus as stated above, including a light strip mounted on the housing of the scanning apparatus.

It can be seen that the present disclosure has the following beneficial effects.

In the present disclosure, the scanning condition of a scanning apparatus is converted into a control instruction for controlling a light strip to provide the indication, the control instruction can be executed to control the light strip on the exterior of the scanning apparatus to indicate the scanning process when the scanning condition of the medical-scanning apparatus occurs. In this way, a synchronous operation of the scanning process and the indication is achieved intuitively, visually and recognizably, the patient can know the scanning progress from the exterior of the device, and the operator can observe the scanning progress directly from the exterior of the device and observe the patient simultaneously.

### BRIEF DESCRIPTION OF THE DRAWINGS

FIG. 1 is a schematic flow chart of a method for indicating a scanning condition according to the present disclosure;

FIG. 2 is a schematic composition diagram of a device for indicating a scanning condition according to the present disclosure;

FIG. 3 is a schematic composition diagram of a scanning apparatus according to the present disclosure;

FIG. 4 is a schematic cross section view of a housing of a scanning apparatus according to the present disclosure; and

FIG. 5 is a schematic composition diagram of a scanning system according to the present disclosure.

### DETAILED DESCRIPTION OF THE INVENTION

In order to better understand the above purpose, feature and advantage of the present disclosure, embodiments of the present disclosure will be explained in detail in conjunction with accompanying drawings and specific embodiments.

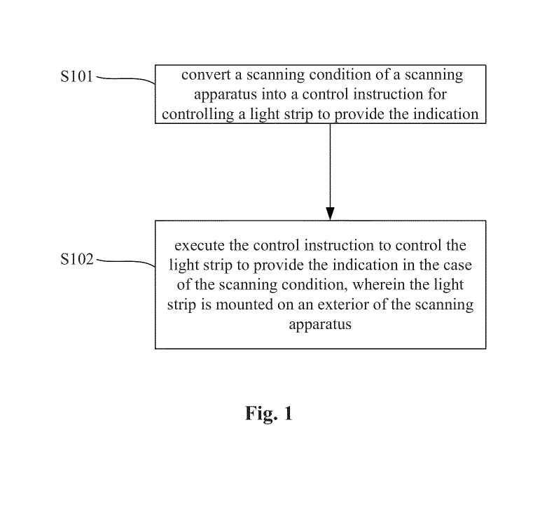

Referring to FIG. 1, a schematic flow chart of a method for indicating a scanning condition provided by the present disclosure is shown. The method includes step S101-step 102.

S101, converting a scanning condition of a scanning apparatus into a control instruction for controlling a light strip to provide an indication; and

S102, executing the control instruction for controlling the light strip to provide the indication in the case of the scanning condition, wherein the light strip is mounted on an exterior of the scanning apparatus.

It can be seen that according to the embodiments of the present disclosure, when the scanning condition of the medical-scanning device occurs, the light strip on the exterior of the scanning apparatus can be controlled to indicate changes of the condition by converting the scanning condition of the scanning apparatus into the control instruction for controlling the light strip to provide the indication. In this way, the synchronously displaying of the scanning process is achieved intuitively, visually and recognizably.

In an embodiment of the present disclosure, the scanning condition of the scanning apparatus may include a scanning process condition of the scanning apparatus; and the method may include:

the converting the scanning condition of the scanning apparatus into the control instruction for controlling the light strip to provide the indication includes converting the scanning process condition of the scanning apparatus into the control instruction for controlling the light strip to provide the indication; and

executing the control instruction in the case that the scanning process condition.

In another embodiment of the present disclosure, the scanning condition of the scanning apparatus includes a working condition of the scanning apparatus and a fault condition of the scanning apparatus; and the method may include:

the converting the scanning condition of the scanning apparatus into the control instruction for controlling the light strip to provide the indication includes: converting the working condition of the scanning apparatus into a first control instruction for controlling the light strip to provide the indication, and converting a fault condition of the scanning apparatus into a second control instruction for controlling the light strip to provide the indication; and

the executing the control instruction to control the light strip to provide the indication in the case of the scanning condition includes: executing the first control instruction for controlling the light strip to provide the indication in the case of the working condition, and executing the second control instruction for controlling the light strip to provide the indication in the case of the fault condition.

It should be noted that the scanning condition mentioned in the present disclosure may be the scanning process condition of the scanning apparatus; or the working condition, fault condition; or non-working condition; or any other scanning condition of the scanning apparatus. Each embodiment of the scanning condition of the scanning apparatus aforementioned in the present disclosure is only an exemplary embodiment, and is not intended to limit the present disclosure.

Specifically, the executing the control instruction for controlling the light strip to provide the indication may include:

sending the control instruction to a light strip control device, in which the light strip control device executes the control instruction for controlling the light strip to provide the indication.

Specifically, the sending the control instruction to the light strip control device may include:

sending the control instruction to a frame control system, and then send by the frame control system the control instruction to the light strip control device.

Specifically, the sending the control instruction to the frame control system may include sending the control instruction to the frame control system via the Ethernet or a serial bus. The send by the frame control system the control instruction to the light strip control device may include: sending by the frame control system the control instruction to the light strip control device via a serial bus. The operate the light strip control device to execute the control instruction for controlling the light strip to provide the indication may include: controlling the light strip to provide the indication by the light strip control device via a light strip control bus, or other bus set as required by specific implementation.

It should be noted that the control instruction is sent to a light strip control device in the aforementioned embodiment, such that the light strip control device executes the control instruction for controlling the light strip to provide the indication. However, the control instruction according to the present disclosure may also be sent directly to the light strip to control the light strip to provide the indication, or the control instruction may also be sent to any other devices adapted to control the light strip, by which the light strip is controlled to provide the indication, which are not limited in the present disclosure and can be set as required by specific implementation.

It should be noted that the executing the control instruction for controlling the light strip to provide the indication may include executing the control instruction for controlling separately each light in the light strip to provide the indication, and for controlling luminance and color. In addition, the communication between the light strip control device and the light strip may be achieved by adopting a corresponding light strip control bus according to the control chip in the light strip. The applicative light strip may be e.g. LED light strip.

The specific embodiments for convening the scanning process condition into the control instruction for controlling the light strip to provide the indication will be explained in detail below.

### First Embodiment

A beginning condition of the scanning process is convened into a control instruction for controlling a front of the light strip to emit light for providing an indication.

A process from the beginning condition to an ending condition of the scanning process is converted into a control instruction for controlling the light strip to emit light for providing the indication sequentially in a direction away from the front.

### Second Embodiment

A beginning condition of the scanning process is converted into a control instruction for controlling the light strip to emit light for providing an indication entirely and simultaneously.

A process from the beginning condition to an ending condition of the scanning process is converted into a control instruction for controlling the light strip to be changed from emitting light for providing an indication entirely and simultaneously to turning off one by one sequentially.

### Third Embodiment

A process from a beginning condition to a condition before an ending condition of the scanning process is converted into a control instruction for controlling the light strip to alternately switch between emitting light for providing an indication entirely and furthest and turning off entirely.

The ending condition of the scanning process is converted into a control instruction for controlling the light strip to turn off entirely.

### Fourth Embodiment

A process from a beginning condition to an ending condition of the scanning process is converted into a control instruction for controlling the light strip to emit light for providing an indication in a gradual-luminance mode.

The ending condition of the scanning process is converted into a control instruction for controlling the light strip to turn off entirely.

### Fifth Embodiment

A process from a beginning condition to an ending condition of the scanning process is divided into a plurality of stages.

Each of the stages is converted into a control instruction for controlling one segment of the light strip to emit light for providing an indication.

In addition, with the processing of each stage one by one, the luminance of the one segment of the light strip controlled by the control instruction to emit light for providing an indication may change gradually.

In the aforementioned embodiments, the control instruction for controlling the light strip to provide the indication includes the control instruction for controlling the light strip to provide the indication separately or integrally in color or luminance according to changes of the scanning condition.

It should be noted that the scanning process condition may be a whole process condition during the scanning, and may also be a process condition of a certain stage during the scanning process. For example, the scanning process may be a scanning process of the expiratory stage and the suffocating stage of a patient during the scanning. Specifically, according to the present disclosure, the light strip can be controlled to provide different indications at the expiratory stage and the suffocating stage during the scanning, such that the patient can adjust breath according to the different indications of the light strip, and the indication of the scanning condition is achieved.

The step of executing the control instruction for controlling the light strip to provide the indication in the case of the scanning condition will be explained in detail below.

The control instruction corresponding to a stage is triggered to be executed according to the occurrence of the stage condition when the scanning process proceeds to the stage condition, based on the control instruction converted correspondingly from the stage conditions during the scanning process.

Alternatively, the control instruction for controlling the light strip to provide the indication is triggered to be executed at the beginning of the scanning process condition. The execution speed of the control instruction corresponds to the change speed of the scanning process condition, such that the indication of the light strip corresponds to the change of the scanning process condition.

Specifically, the control instruction may include instructions for controlling parameters such as the emitting position, the emitting time, the emitting luminance and the emitting color of the light strip.

It should be noted that the present disclosure can be applied widely to various scanning apparatus, including but not limited to e.g. CT apparatus, MRI apparatus, PET apparatus, PET-CT apparatus or X-ray apparatus.

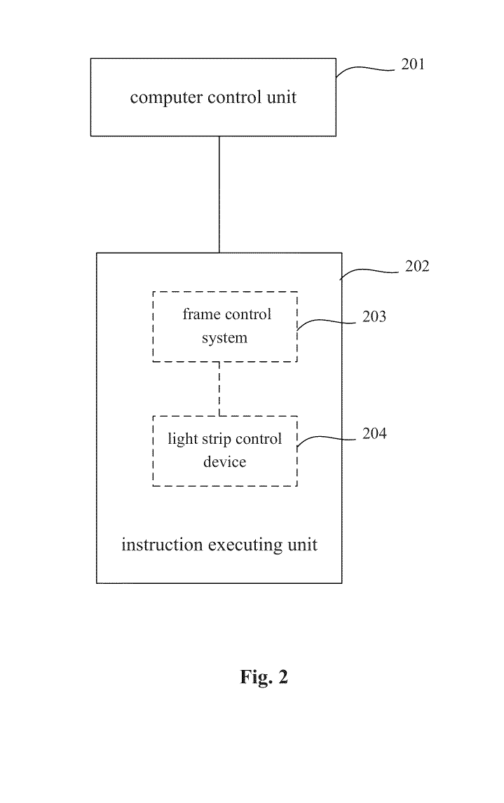

Referring to FIG. 2, a schematic composition diagram of a device for indicating a scanning condition is shown according to the present disclosure. The device includes:

a computer control unit 201 adapted to convert a scanning condition of a scanning apparatus into a control instruction for controlling a light strip to provide an indication, and send the control instruction to an instruction executing unit 202; and

the instruction executing unit 202 adapted to execute the control instruction for controlling the light strip to provide the indication in the case of the scanning condition, wherein the light strip is mounted on an exterior of the scanning apparatus.

In an embodiment of the present disclosure,

the computer control unit 201 is adapted to convert a scanning process condition of the scanning apparatus into the control instruction for controlling the light strip to provide the indication; and

the instruction executing unit 202 is adapted to execute the control instruction for controlling the light strip to provide the indication in the case of the scanning process condition.

In another embodiment of the present disclosure;

the computer control unit 201 is adapted to convert a working condition of the scanning apparatus into a first control instruction for controlling the light strip to provide the indication, and to convert a fault condition of the scanning apparatus into a second control instruction for controlling the light strip to provide the indication; and

the instruction executing unit 202 is adapted to execute the first control instruction for controlling the light strip to provide the indication in the case of the working condition, and to execute the second control instruction for controlling the light strip to provide the indication in the case of the fault condition.

It should be noted that the scanning condition mentioned in the present disclosure may be the scanning process condition of the scanning apparatus; or the working condition, fault condition; or non-working condition; or any other scanning condition of the scanning apparatus. Each embodiment of the scanning condition of the scanning apparatus aforementioned in the present disclosure is only an exemplary embodiment, and is not intended to limit the present disclosure.

In an embodiment of the device according to the present disclosure, the instruction executing unit 202 is adapted to operate the light strip control device 204 to execute the control instruction for controlling the light strip to provide the indication in the case of the scanning condition. The light strip control device may be e.g. a light strip control board.

Specifically, the instruction executing unit 202 is adapted to send the control instruction to a frame control system, such that the frame control system sends the control instruction to the light strip control device, to operate the light strip control device to execute the control instruction for controlling the light strip to provide the indication.

Specifically, the instruction executing unit 202 is adapted to send the control instruction to the frame control system via the Ethernet or a serial bus, such that the frame control system sends the control instruction to the light strip control device via a serial bus, to operate the light strip control device to control the light strip to provide the indication via a light strip control bus.

It should be noted that the control instruction may be sent to the light strip control device by the instruction executing unit 202 in aforementioned embodiment, such that the light strip control device executes the control instruction for controlling the light strip to provide the indication. However, the control instruction according to the present disclosure may also be sent directly to the light strip by the instruction executing unit 202 to control the light strip to provide the indication, or the control instruction may also be sent to any other devices adapted to control the light strip, by which the light strip is controlled to provide the indication, which are not limited in the present disclosure.

Specific embodiments of the computer control unit 201 will be explained in detail.

The computer control unit 201 is adapted to convert a beginning condition of the scanning process into a control instruction for controlling a front of the light strip to emit light for providing an indication, and to convert a process from the beginning condition to an ending condition of the scanning process into a control instruction for controlling the light strip to emit light for providing the indication sequentially in a direction away from the front.

Alternatively, the computer control unit 201 is adapted to convert a beginning condition of the scanning process into a control instruction for controlling the light strip to emit light for providing an indication entirely and simultaneously, and to convert a process from the beginning condition to an ending condition of the scanning process into a control instruction for controlling the light strip to be changed from emitting light for providing the indication entirely and simultaneously to turning off one by one sequentially.

Alternatively, the computer control unit 201 is adapted to convert a process from a beginning condition to a condition before an ending condition of the scanning process into a control instruction for controlling the light strip to alternately switch between emitting light for providing an indication entirely and furthest and turning off entirely, and to convert the ending condition of the scanning process into a control instruction for controlling the light strip to turn off entirely.

Alternatively, the computer control unit 201 is adapted to convert a process from a beginning condition to an ending condition of the scanning process into a control instruction for controlling the light strip to emit light for providing an indication in a gradual-luminance mode, and to convert the finishing condition of the scanning process into a control instruction for controlling the light strip to turn off entirely.

Alternatively, the computer control unit 201 is adapted to divide a process from a beginning condition to an ending condition of the scanning process into a plurality of stages, and to convert each of the stages into a control instruction for controlling one segment of the light strip to emit light for providing an indication.

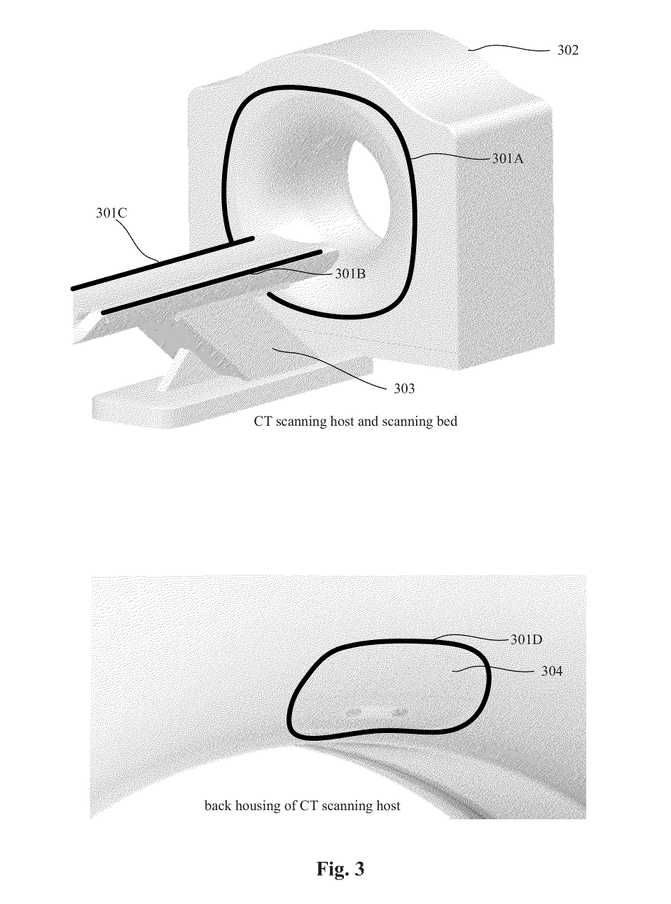

Reference is made to FIG. 3, a scanning device according to the present disclosure is shown, in which a light strip is mounted on a housing of the scanning device, and the light strip is adapted to provide an indication correspondingly in the case of the scanning condition.

The light strip may be e.g. light strips 301A, 301B, 301C and 301D as shown in FIG. 3.

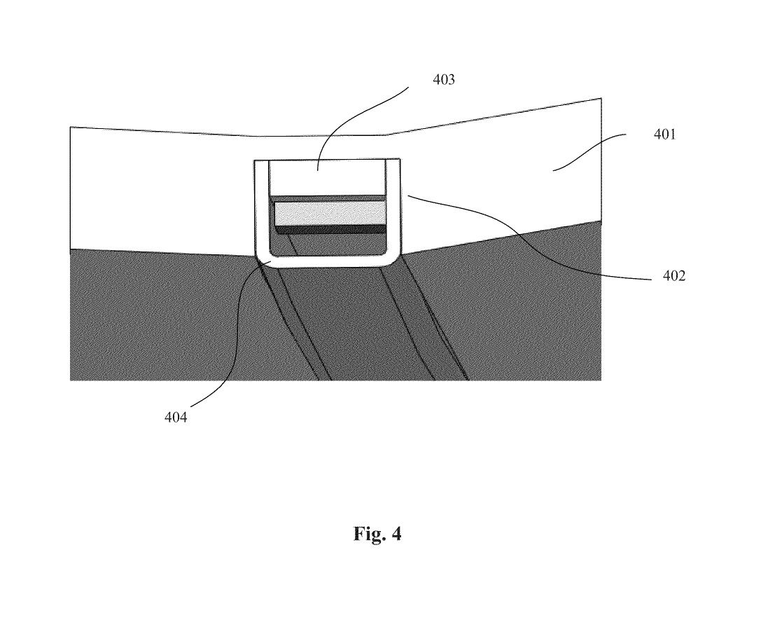

A schematic cross section view of a housing of a scanning host is shown in FIG. 4. The surface of the housing 401 of the scanning host may have a light strip groove 402, and the light strip 403 may be mounted in the light strip groove 402.

Specifically, a light strip lid 404 is mounted on the light strip groove 402. In the case that the light strip groove is covered with the light strip lid 404, the light strip 403 may be closed into the light strip groove 402 when the light strip 403 is placed in the light strip groove 402. The light strip cover 404 is made of transparent materials, e.g. transparent plastic.

The light strip may be in annular, linear or any shape.

The light strip is any one or a combination of:

a LED light strip including LED luminescent tubes and a light control chip:

a light strip including edge lit photoconductive materials; or

a bar-like light strip including independent illuminants or photoconductive materials formed in a straight line or an arc.

Specifically, the color or luminance of the light strip is controlled separately or integrally to correspond to the change of a scanning condition.

As shown in FIG. 3, the scanning apparatus may be a CT scanning apparatus. The light strip mounted on the housing of the CT scanning host includes any one or a combination of:

the light strip 301A mounted on a principal plane of a front housing of the CT scanning host 302 as shown in FIG. 3;

the light strips 301B and 301C mounted at the middle position of each of housings at the left and right sides of the scanning bed 303 as shown in FIG. 3; or

a circle of light strip 301D mounted around the breathing navigation component at the back housing 304 of the CT scanning host as shown in FIG. 3.

It should be noted that the present disclosure can be applied widely to various scanning apparatus, including but not limited to e.g. CT apparatus. MRI apparatus, PET apparatus, PET-CT apparatus or X-ray apparatus.

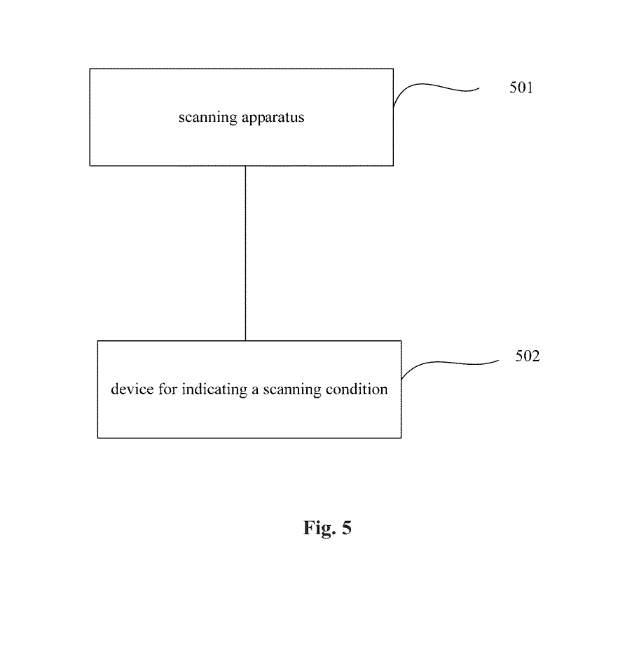

Referring to FIG. 5, a scanning system according to the present disclosure is shown. The system includes:

a scanning apparatus 501 according to the aforementioned embodiments, in which a light strip is mounted on a housing of the scanning apparatus; and

a device 502 for indicating the scanning condition according to the aforementioned embodiments, adapted to convert the scanning condition of a scanning apparatus into a control instruction for controlling a light strip to provide the indication, and to execute the control instruction for controlling the light strip to provide the indication in the case of the scanning condition, in which the light strip is mounted on the exterior of the scanning apparatus.

It should be noted in the present disclosure that relational terms, such as “the first” and “the second”, are only used to distinguish one entity or operation from another entity or operation, but not request or imply that there is any of such kind of practical relationship or order between these entities or operations. Moreover, terms, such as “include”, “contain” or any other variations thereof, are intended to cover a non-exclusive containing, such that a process, method, article or device including a series of elements, includes not only those elements, but also other elements which are not listed explicitly, or also includes elements which is inherent to the process, method, article or device. In the cases where there are no further limits, elements limited by a sentence “includes one . . . ” does not exclude the presence of other same elements in the process, method, article or device including the elements.

The aforementioned are only preferred embodiments of the present disclosure, which are not intended to limit the scope of protection of the present disclosure. Any modification, replacement, improvement and the like made within the spirit and principle of the present disclosure will be within the scope of protection of the present disclosure.

1. A method for indicating a scanning condition, comprising:
converting a scanning condition of a scanning apparatus into a control instruction for controlling a light strip to provide an indication; and
executing the control instruction for controlling the light strip to provide the indication in the case of the scanning condition, wherein the light strip is mounted on an exterior of the scanning apparatus.

2. The method according to claim 1, wherein the converting the scanning condition of a scanning apparatus into a control instruction for controlling a light strip to provide an indication comprises converting a scanning process condition of the scanning apparatus into the control instruction for controlling the light strip to provide the indication; and
the executing the control instruction in the case of the scanning condition comprises executing the control instruction in the case of the scanning process condition.

3. The method according to claim 1, wherein the converting the scanning condition of a scanning apparatus into a control instruction for controlling a light strip to provide an indication comprises: converting a working condition of the scanning apparatus into a first control instruction for controlling the light strip to provide the indication, and converting a fault condition of the scanning apparatus into a second control instruction for controlling the light strip to provide the indication; and
the executing the control instruction for controlling the light strip to provide the indication in the case of the scanning condition comprises: executing the first control instruction for controlling the light strip to provide the indication in the case of the working condition, and executing the second control instruction for controlling the light strip to provide the indication in the case of the fault condition.

4. The method according to claim 1, wherein the executing the control instruction to control the light strip to provide the indication comprises:
sending the control instruction to a light strip control device, wherein the light strip control device executes the control instruction for controlling the light strip to provide the indication.

5. The method according to claim 4, wherein the sending the control instruction to the light strip control device comprises:
sending the control instruction to a frame control system, and send by the frame control system the control instruction to the light strip control device.

6. The method according to claim 5, wherein the sending the control instruction to a frame control system comprises sending the control instruction to the frame control system via the Ethernet or a serial bus; and
the send by the frame control system the control instruction to the light strip control device comprises: send by the frame control system the control instruction to the light strip control device via a serial bus,
wherein the light strip control device executes the control instruction for controlling the light strip to provide the indication comprises: control the light strip to provide the indication by the light strip control device via a light strip control bus.

7. The method according to claim 2, wherein the converting the scanning process condition of the scanning apparatus into the control instruction for controlling the light strip to provide the indication comprises:
converting a beginning condition of a scanning process into a control instruction for controlling a front of the light strip to emit light for providing the indication, and converting a process from the beginning condition to an ending condition of the scanning process into a control instruction for controlling the light strip to emit light for providing the indication sequentially in a direction away from the front; or
converting a beginning condition of a scanning process into a control instruction for controlling the light strip to emit light for providing the indication entirely and simultaneously, and converting a process from the beginning condition to an ending condition of the scanning process into a control instruction for controlling the light strip to be changed from emitting light for providing the indication entirely and simultaneously to turning off one by one sequentially; or
converting a process from a beginning condition to a condition before an ending condition of the scanning process into a control instruction for controlling the light strip to alternately switch between emitting light for providing an indication entirely and furthest and turning off entirely, and converting the ending condition of the scanning process into a control instruction for controlling the light strip to turn off entirely; or
converting a process from a beginning condition to an ending condition of the scanning process into a control instruction for controlling the light strip to emit light for providing the indication in a gradual-luminance mode, and converting the ending condition of the scanning process into a control instruction for controlling the light strip to turn off entirely; or
dividing a process from a beginning condition to an ending condition of the scanning process into a plurality of stages, and converting each of the stages into a control instruction for controlling one segment of the light strip to emit light for providing the indication.

8. The method according to claim 1, wherein the operate the light strip control device to execute the control instruction for controlling the light strip to provide the indication comprises: operate the light strip control device to execute the control instruction for controlling the light strip to provide the indication separately or integrally in color or luminance, wherein the indication correspond to changes of the scanning condition.

9. The method according to claim 1, wherein the scanning apparatus comprises CT apparatus, MRI apparatus, PET apparatus, PET-CT apparatus or X-ray apparatus.

10. A device for indicating a scanning condition, comprising:
a computer control unit adapted to convert a scanning condition of a scanning apparatus into a control instruction for controlling a light strip to provide an indication, and send the control instruction to an instruction executing unit; and
the instruction executing unit adapted to execute the control instruction for controlling the light strip to provide the indication in the case of the scanning condition, wherein the light strip is mounted on an exterior of the scanning apparatus.

11. The device according to claim 10, wherein the computer control unit is adapted to convert a scanning process condition of the scanning apparatus into the control instruction for controlling the light strip to provide the indication; and
the instruction executing unit is adapted to execute the control instruction for controlling the light strip to provide the indication in the case of the scanning process condition.

12. The device according to claim 10, wherein the computer control unit is adapted to convert a working condition of the scanning apparatus into a first control instruction for controlling the light strip to provide the indication, and to convert a fault condition of the scanning apparatus into a second control instruction for controlling the light strip to provide the indication; and
the instruction executing unit is adapted to execute the first control instruction for controlling the light strip to provide the indication in the case of the working condition, and to execute the second control instruction for controlling the light strip to provide the indication in the case of the fault condition.

13. The device according to claim 10, wherein the instruction executing unit is adapted to operate a light strip control device to execute the control instruction for controlling the light strip to provide the indication in the case of the scanning condition.

14. The device according to claim 13, wherein the instruction executing unit is adapted to send the control instruction to a frame control system, so as to send by the frame control system the control instruction to the light strip control device, wherein the light strip control device executes the control instruction for controlling the light strip to provide the indication.

15. The device according to claim 11, wherein the computer control unit is adapted to convert a beginning condition of a scanning process into a control instruction for controlling a front of the light strip to emit light for to provide the indication, and to convert a process from the beginning condition to an ending condition of the scanning process into a control instruction for controlling the light strip to emit light for providing the indication sequentially in a direction away from the front; or
the computer control unit is adapted to convert a beginning condition of the scanning process into a control instruction for controlling the light strip to emit light for providing the indication entirely and simultaneously, and to convert a process from the beginning condition to an ending condition of the scanning process into a control instruction for controlling the light strip to be changed from emitting light for providing the indication entirely and simultaneously to turning off one by one sequentially; or
the computer control unit is adapted to convert a process from a beginning condition to a condition before an ending condition of the scanning process into a control instruction for controlling the light strip to alternately switch between emitting light for providing the indication entirely and furthest and turning off entirely, and to convert the ending condition of the scanning process into a control instruction for controlling the light strip to turn off entirely; or
the computer control unit is adapted to convert a process from a beginning condition to an ending condition of the scanning process into a control instruction for controlling the light strip to emit light for providing the indication in a gradual-luminance mode, and to convert the ending condition of the scanning process into a control instruction for controlling the light strip to turn off entirely; or
the computer control unit is adapted to divide a process from a beginning condition to an ending condition of the scanning process into a plurality of stages, and to convert each of the stages into a control instruction for controlling one segment of the light strip to emit light for providing the indication.

16. A scanning apparatus, comprising a light strip mounted on a housing of the scanning apparatus.

17. The scanning apparatus according to claim 16, wherein a light strip groove is provided on the surface of a housing of a scanning host, the light strip is mounted in the light strip groove, a light strip lid is mounted on the light strip groove, and in the case that the light strip is placed in the light strip groove and the light strip groove is covered with the light strip lid, the light strip is closed into the light strip groove, wherein the light strip lid is made of a transparent material.

18. The scanning apparatus according to claim 16, wherein the light strip is any one or a combination of:
a LED light strip; or
a light strip including edge lit photoconductive materials; or
a bar-like light strip including independent illuminants or photoconductive materials formed in a straight line or an arc.

19. The scanning apparatus according to claim 16, wherein the color or luminance of the light strip is controlled separately or integrally to correspond to a change of a scanning condition.

20. The scanning apparatus according to claim 16, wherein the scanning apparatus is a CT scanning apparatus, and the light strip mounted on the housing of the CT scanning host comprises any one or a combination of:
a light strip mounted on a principal plane of a front housing of the CT scanning host; or
a light strip mounted at the middle position of each of housings at the left and right sides of a scanning bed of the CT scanning host; or
a circle of light strip mounted around the breathing navigation component at the back housing of the CT scanning host.
